(19) United States
(12) Patent Application Publication
(10) Pub. No.: US 2002/0015572 A1
(43) Pub. Date: Feb. 7, 2002

(54) Passive optical attenuator

(76) Inventors: Jamieson Wesley Hoover, Ottawa (CA); William Thomas Moore, Ottawa (CA); Juliusz Szereszewski, Ottawa (CA)

Correspondence Address: Juliusz Szereszewski, Registered Paten Agent, Intellectual Prop. Dept., JDS Uniphase Corporation, 1187 Bank Street, Suite 201, Ottawa, ON, K1S 3X7, CA

(21) Appl. No.: 09/859,492

(22) Filed: May 18, 2001

Related U.S. Application Data
(60) Provisional application No. 60/214,164, filed on Jun. 26, 2000.

(51) Int. Cl. G02B 6/26

(52) U.S. Cl. 385/140

(57) ABSTRACT

A variable optical attenuator has a mirror facing an input waveguide end and an output waveguide end. A lens is mounted in the optical path between the waveguide ends and the mirror. The waveguide ends, mirror and lens are mounted on thermally expansible elements, and the position of the mirror with the lens relative to the waveguide ends is linearly displaceable by differential thermal expansion.

### FIELD OF THE INVENTION

This invention is concerned with variable optical signal attenuators, and more particularly with passive optical attenuators employed in fiber-optic transmission systems wherein the efficiency of transmission from an input port or waveguide to an output port or waveguide is controlled.

### BACKGROUND OF THE INVENTION

Attenuators, or attenuating couplers are well known and widely used in optical transmission systems. Various control mechanisms are employed to control the attenuation of optical signal transmitted between two or more waveguides. Simplicity, small size, reliability and resistance to wear are some of the requirements that the attenuating devices should meet. Several designs of attenuators, employing various types of actuators or control means have been proposed in the patent literature. It is known from U.S. Pat. No. 5,915,063 to Colbourne et al., to use an actuator with a thermally expansible member to control the angular position of a mirror, wherein heat applied to the expansible member will cause an elongation of the member. An asymmetric elongation of the actuator will in turn cause a controlled tilting of the mirror that reflects an optical signal beam between input and output waveguides.

Lance et al, U.S. Pat. No. 4,516,827, proposes a variable attenuator having two optical fibers and a movably mounted reflective surface disposed therebetween.

In a fiber optic system, there is sometimes a need for a passive attenuator, one that does not require outside energy or stimulus to effect a change in attenuation of an optical signal. For example, it may be desirable to compensate for a temperature-dependent power shift of a pump laser to maintain the power of the laser output beam at a relatively constant level. It may therefore be desirable to provide a compensation of this power variance by installing an attenuator in the path of the laser beam, the attenuator's performance designed to provide an attenuating effect as a function of temperature change, of an opposite effect to the laser power change due to the same temperature change. In other words, it is desirable to provide a passive optical attenuator for attenuating an optical signal as a function of ambient temperature, without controlled selective application of heat, pressure, electric voltage etc. to one of its elements.

### SUMMARY OF THE INVENTION

In accordance with the invention, there is provided a variable optical attenuator comprising:

an input port for emitting an optical signal beam,

an output port for receiving an optical signal beam,

a focusing means disposed in the optical path between the input port and the output port for focusing or defocusing the optical signal beam on the output port, and

an actuator operable in response to ambient temperature for linearly displacing the focusing means relative to at least one of the input port and the output port to cause the focusing or defocusing of the optical signal beam on the output port.

The displacement may be effected substantially in a linear manner along a linear axis, i.e. without changing the angular relationship of the focusing means and the input port or the output port.

The actuator may be one operable by differential thermal expansion.

In accordance with another aspect of the invention, there is provided an optical attenuator comprising:

a reflective surface for receiving and reflecting an incident optical signal beam,

an input port for emitting an incident optical beam towards the reflective surface,

an output port for receiving the reflected optical beam upon reflection of the incident beam from the reflective surface, the reflective surface spaced from at least one of the input and output port, and

a thermally expansible actuator for linearly displacing the reflective surface relative to at least one of the input port and the output port to change the direction of the reflected optical beam relative to the output port.

The definition “reflective” encompasses “partly reflective”.

The actuator may be one operable by differential thermal expansion.

The attenuator may further comprise at least one focusing means disposed between the reflective surface and either the input port, the output port or both to facilitate the focusing of the reflected beam on the output port.

The actuator may be a non-binary actuator operatively connected to the reflective surface for linear displacement of the reflective surface towards or away from at least one of the input port and the output port. Alternatively, the actuator may be operatively connected to one or both ports for the same purpose, i.e. for changing the spacing between the reflective surface and at least the output port. This change has the effect of axially changing the alignment, or shifting, of the reflected beam in parallel to its initial direction. The term “linear” means that essentially no angular displacement of the mirror or other elements of the attenuator is intended, in contrast to e.g. the device of U.S. Pat. No. 5,915,063. The reflective surface and the output port (and optionally also the input port) are brought towards or away from each other in a linear manner. This axial alignment has the effect of a change of transmission between the input port and the output port, a change that is promoted and precisely controlled by the provision of a lens between the reflective surface and the output port (and optionally also between the reflective surface and the input port). Because of the provision of the lens, the axial alignment translates into focusing or defocusing of the optical beam as will be explained below.

The actuator may be an actuator for controlling, in a non-binary manner, a linear spacing between the reflective surface and the output port. The term “thermally expansible actuator” denotes that the actuator comprises a thermally expansible element or a number of thermally expansible elements.

A first waveguide and a second waveguide may be connected to the input port and the output port respectively. In one embodiment of the invention, both waveguides are disposed proximate to each other to reduce the angle of incidence on the reflective surface. In another embodiment of the invention, the waveguides are disposed at distal ends of the attenuator with focusing means in the optical path between the waveguide ends.

The device may comprise a base or a guide, a reflective element mounted on the base, an input waveguide end mounted on the base to launch an input optical signal beam towards the reflective surface, an output waveguide end mounted on the base to receive a reflected optical signal beam upon reflection of the input signal beam from said surface, the reflective surface spaced from the input waveguide end and the output waveguide end in a predetermined angular relationship thereto. A thermal actuator having a thermally expansible element, may also be disposed on or in the base or guide for controlling a distance between the reflective element and at least one of the input and output waveguide ends upon a change of temperature of the thermally expansible element. A lens may be disposed between the reflected element and the output waveguide and spaced from the output waveguide by approximately a focal distance of the lens such that when the actuator is activated, the distance between the reflective surface and the output waveguide end changes thereby bringing the reflected beam, via the lens, into focus on the output waveguide or out of focus.

The focusing means may be a lens, e.g. a GRIN lens. It may be mounted either in a proximity to the waveguide ends or in a proximity to the mirror/reflective element. At least one of the spacing, either between the lens and the output port or between the lens and the mirror, is controlled by the operation of the actuator to obtain the attenuating effect.

### BRIEF DESCRIPTION OF THE DRAWINGS

The invention and its embodiments will be explained in more detail by way of the following description to be taken in conjunction with the drawings in which

FIG. 1 is a schematic cross-sectional view of an embodiment of the present invention,

FIG. 2 and FIG. 3 are schematic representations of the operation of the embodiment of FIG. 1,

FIG. 4 is a schematic representation of another embodiment of the invention,

FIG. 5 is a schematic representation of the operation of the embodiment of FIG. 4, and

FIG. 6 is a schematic representation of still another embodiment of the invention.

### DETAILED DESCRIPTION OF THE INVENTION

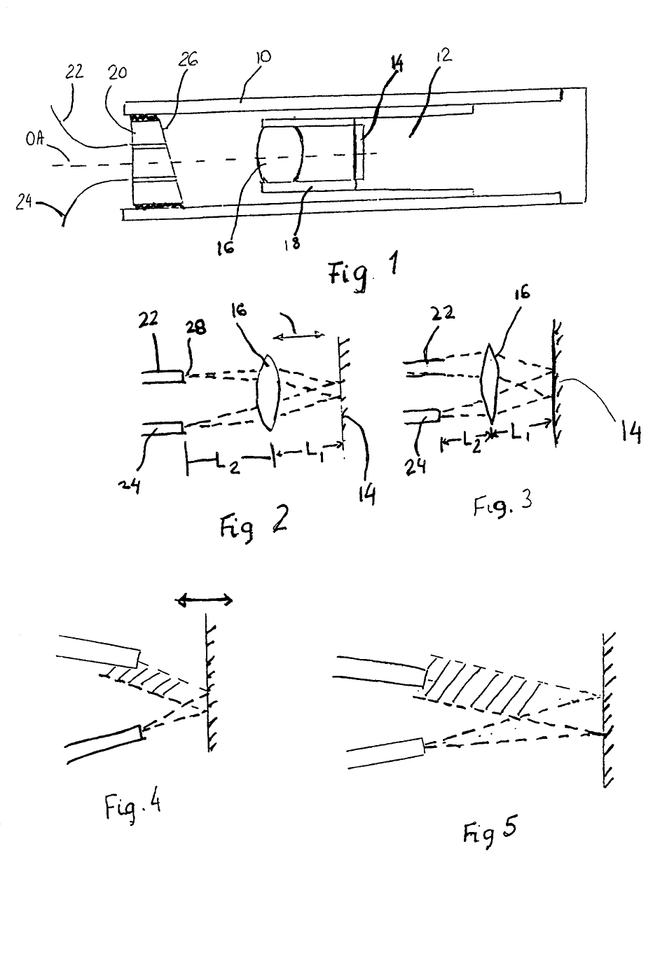

As illustrated in FIG. 1, an exemplary attenuator of the invention has a sleeve 10 made of a high CTE material e.g. steel. A stack 12, made of a low CTE material, e.g. Kovar, is welded or glued to the sleeve 10 and extends axially within the sleeve. Mounted on the stack 12 are a mirror 14 and a lens 16. The lens 16 is mounted on a spacer 18, also made of Kovar.

Facing the lens and axially mounted in the sleeve 10 is a double fiber glass tube 20 with two optical fibers 22, 24 mounted in the tube such that the polished ends of the fibers are ground flat with the face 26 of the tube 20. In order to minimize back reflection, the face 26 is ground at a small angle, about 60, to the vertical as seen in exaggeration in FIG. 1.

The optical axis of the sleeve, lens and fiber tube is indicated as OA.

The coefficients of thermal expansion (CTE) of the materials used are shown in the enclosed table:

TABLE 1
Component materials and CTE.

| | | Coefficient of thermal |
|---|---|---|
| Component | Material | Expansion (PPM/° C.) |
| Centerpiece sleeve | steel | 18 |
| Focus | (air gap) | — |
| Mirror stack | KOVAR | 5 |
| Spacer | KOVAR | 5 |

The GTE difference between steel and Kovar will cause a differential expansion of the materials of the device, particularly the sleeve and the stack, and as a result, a difference in the linear distance between the lens 16 and the ends of the fibers 22, 24. The linear displacement is clearly different than the angular displacement of the prior art Colbourne U.S. Pat. No. 5,915,063.

FIG. 2 and FIG. 3 show the focusing of the optical beam at two temperatures. For the higher temperature (FIG. 2), the distance L₂ between the lens 16 and the output fiber end 28 is such that the beam launched from the input fiber 24 passes through the lens 16, reflects from the mirror 14, passes again through the lens and focuses on the tip 28 of the output fiber. Thus, the optical alignment is at the optimum and the attenuation of the input signal is relatively low.

When the temperature changes, the resulting differential thermal expansion/contraction of the actuator causes misalignment of some elements of the attenuator and consequently a signal attenuation.

In the embodiment of FIG. 2 and FIG. 3, the distance L₁ does not change significantly when the temperature changes because of the low CTE of the spacer 18. It should be noted that the distance L₁ is selected to collimate the input beam on the mirror. In contrast, the lens-to-fiber distance L₂ changes as the sleeve 10 and the stack 12 change length. Since the focal distance of the lens does not vary significantly with temperature, the change of distance L₂ will result in a de-focusing of the beam on the output fiber 22 and hence a greater attenuation.

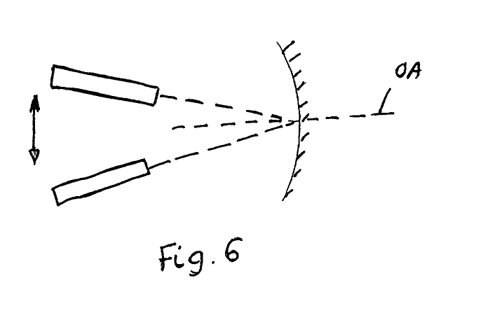

In the embodiment of FIG. 4, a double fiber tube 20 and a lens 16 are mounted in a sleeve 30 that is fixedly attached to a base 32 via a post 34. A spherical concave mirror 36 is fixed to the base 32 via a post 38. The post 34 and the sleeve 30 are made of a low CTE material, while the post 38 is made of a high CTE material. Also, the length of the post 38 is significantly greater than the length of the post 34. In a specific ambient temperature, the device may be calibrated so that an optical beam launched from one of the fibers 22 passes through the lens 16, reflects from the mirror 36 and passes again through the lens 16 to become focused on the end of the other fiber 24. When the ambient temperature changes, the difference in thermal expansion of the posts 34 and 38 will cause the mirror to become vertically displaced, as shown with the arrow, relative to the lens and the fiber tube. As a result, optical beam launched from the fiber 22 will impinge on another spot of the mirror and because of the curvature of the mirror, the reflected beam will be defocused from the end of the fiber 24.

The focusing/defocusing effect will be achieved with a non-planar mirror of another curvature, e.g. parabolic, ellipsoidal etc.

It will also be noted that the provision of a lens is not an absolute necessity for the attenuator to work. The lens or lenses serve to increase the coupling efficiency of the attenuator.

In an alternative embodiment of the invention illustrated schematically in FIG. 5, the actuator is composed of a post 40 that supports the double fiber tube 20 and a post 42 that supports a lens 44. Differential thermal expansion of the actuator 40, 42 and consequently a differential displacement of the lens relative to the output fiber end and input fiber end i.e. the input port and the output port, respectively, causes a shift of an optical beam on its path from the input port through the lens and back as reflected from the mirror. Consequently, focusing or defocusing of the beam (or in other words, a change of coupling efficiency) will take place as a result of a change in ambient temperature.

It will be noted that in all the embodiments illustrated herein, the attenuator is a passive one as the actuator is devoid of an active control member or element e.g. a piezoelectric element that requires a voltage to operate. It is of course possible to modify the attenuator of the invention to provide an active actuator e.g. a piezoelectric, magnetostrictive actuator etc.

It will be recognized that, where space saving is of primary concern, the sleeve-mounted embodiment of FIG. 1 is typically more compact than the embodiment of FIG. 5, but both embodiments are within the scope of the invention.

As shown in FIGS. 1-5, the input port and output port are disposed on one side of the lens, and a displacement of the lens and/or the mirror disposed on the other side of the lens affects the focal distance between the lens and one or both ports. This is a so-called “folded” space saving arrangement. However, it is also conceivable to place the lens in the optical path and between the input port and the output port, eliminating the mirror. Either of the ports and the lens may be mounted to a base via a separate support member having a dissimilar CTE. The support members, functioning as actuator, may be designed for relative axial displacement as in FIG. 1 or for a transverse displacement as in FIGS. 4 and 5. A change in ambient temperature would cause a linear displacement of the lens relative to either port amounting to a focusing or defocusing of the optical beam on the output port and a resulting change in attenuation.

Various modifications of the embodiments illustrated and described hereinabove are possible. For instance, the materials of the sleeve and stack may be interchanged resulting in an opposite displacement of the mirror vs. the fibers with a change in temperature. Accordingly, the device may be calibrated such that the minimum attenuation occurs at the room temperature and rises with increasing ambient temperature, or that the minimum attenuation occurs at a preselected elevated temperature and increases as the ambient temperature decreases.

Where a focusing means is recited, it denotes at least one lens or an equivalent element. Specifically, a lens may be associated separately with input port and output port. Fibers with expanded mode field (TEC fibers) may be useful to focus the optical beam for the purposes of the invention. In the embodiments described and illustrated herein, a single lens is provided for economic and space-saving reasons.

As will be recognized by those skilled in the art, the device requires calibration, so that a predetermined attenuation is produced at specific temperatures. The calibration procedure does not require further explanation.

1. An optical attenuator comprising:
an input port for emitting an optical signal beam,
an output port for receiving an optical signal beam,
a focusing means disposed in the optical path between the input port and the output port for focusing or defocusing the optical signal beam on the output port, and
an actuator operable in response to ambient temperature for linearly displacing the focusing means relative to the at least one of the input port and the output port to cause the focusing or defocusing of the optical signal beam on the output port.

2. The optical attenuator according to claim 1 wherein the actuator is operable to effect a linear displacement of the focusing means towards or away from at least one of the input port and the output port.

3. The optical attenuator according to claim 1 wherein the actuator is operable to effect a lateral displacement of the focusing means relative to the at least one of the input port and the output port.

4. The attenuator of claim 1 wherein the focusing means is disposed between the input port and the output port.

5. An optical attenuator comprising:
a reflective surface disposed to receive and reflect an incident optical signal beam,
an input port for emitting an incident optical beam towards the reflective surface,
an output port for receiving the optical beam upon reflection of the incident beam from the reflective surface, the reflective surface spaced from at least one of the input and output port, and
an actuator operable in response to ambient temperature for linearly displacing the focusing means relative to the at least one of the input port and the output port to cause the focusing or defocusing of the optical signal beam on the output port.

6. The attenuator of claim 1 wherein the actuator comprises at least two elements having a dissimilar coefficient of thermal expansion.

7. The attenuator of claim 5 wherein the actuator comprises at least two elements having a dissimilar coefficient of thermal expansion.

8. The attenuator of claim 5 further comprising at least one focusing means disposed between the reflective surface and at least one of the input port and the output port for focusing the reflected beam on the output port.

9. The attenuator of claim 5 wherein the reflective surface has a curved surface and the actuator is operable to effect a lateral displacement of the focusing means relative to the at least one of the input port and the output port.

10. The attenuator of claim 8 wherein the reflective surface has a curved surface and the actuator is operable to effect a lateral displacement of the focusing means relative to at least one of the input port and the output port.

11. The attenuator of claim 8 wherein the actuator is a non-binary actuator operatively connected to the reflective surface for linear displacement of the reflective surface towards or away from at least one of the input port and the output port.

12. The attenuator according to claim 1 wherein the actuator is devoid of active control means.

13. The attenuator of claim 1 further comprising a first waveguide and a second waveguide connected to the input port and the output port respectively, both waveguides disposed proximate to each other.

14. An attenuator for controllably coupling optical energy between an input port and an output port, comprising:
a reflective surface for receiving and reflecting an incident optical signal beam,
an input port for launching the incident beam towards the reflective surface,
an output port for receiving a reflected optical signal beam upon reflection of the incident beam from the reflective surface, the reflective surface spaced from the input and the output port in a predetermined angular relationship, and
an actuator comprising a pair of elements having a dissimilar coefficient of thermal expansion for controlling a linear spacing between the reflective surface and the at least one of the input port and the output port.

15. The attenuator of claim 5, comprising
a base,
a reflective element mounted on the base,
an input waveguide end mounted on the base to launch an input optical signal beam towards the reflective surface,
an output waveguide end mounted on the base to receive a reflected optical signal beam upon reflection of the input signal beam from said surface,
the reflective surface spaced from the input waveguide end and the output waveguide end in a predetermined angular relationship thereto, and
a thermal actuator having a thermally expansible element having a different CTE than the CTE of the base, the actuator disposed for controlling a distance between the reflective element and at least one of the input and output waveguide ends upon a change of ambient temperature.

16. The device of claim 15, further comprising a lens disposed between the reflected element and the output waveguide and spaced from the output waveguide by approximately a focal distance of the lens.
